(19) United States
(12) Patent Application Publication
(10) Pub. No.: US 2024/0339786 A1
(43) Pub. Date: Oct. 10, 2024

(54) HOT SWAP ENERGY STORAGE INTERFACE CONNECTOR AND METHOD

(71) Applicants: High Desert Racing Products, LLC, Reno, NV (US); Hypercraft Inc., Provo, UT (US)

(72) Inventors: Kory Negrich, Provo, UT (US); Jacob Hawksworth, Provo, UT (US)

(21) Appl. No.: 18/627,249

(22) Filed: Apr. 4, 2024

Related U.S. Application Data
(60) Provisional application No. 63/456,924, filed on Apr. 4, 2023.

(51) Int. Cl. H01R 13/631; B60S 5/06; H01M 10/42; H01M 10/6568

(52) U.S. Cl. CPC H01R 13/631; B60S 5/06; H01M 10/425; H01M 10/6568; H01M 2010/4278; H01M 2220/20; H01R 2201/26

(57) ABSTRACT

A hot swap interface connector comprising an interface plate; energy storage connectors comprising a coolant connector; a low voltage and communication connector; a high voltage connector, wherein the hot swap interface connector is an all-in-one mechanical connector configured to allow all of the energy storage connectors into one interface between a vehicle and a hot swappable energy storage device.

### CROSS-REFERENCE TO RELATED APPLICATION

This application claims the benefit of U.S. Provisional Patent Application No. 63/456,924, filed Apr. 4, 2023, under 35 U.S.C. 119 and is incorporated herein in its entirety.

### FIELD OF THE INVENTION

The present invention relates energy storage hot swapping systems and methods.

### BACKGROUND OF THE INVENTION

Hot swapping energy storage systems is meant to be done quickly, however there are multiple connectors that are typically attached to an energy storage unit. These connectors include plumbing for cooling, low voltage, communications, and energy transfer. These connectors have to be released quickly and safely. We are not aware of existing solutions to solve these problems.

### SUMMARY OF THE INVENTION

An aspect of the present disclosure involves a hot swap interface connector that is an all-in-one mechanical connector that allows all energy storage connectors into one interface between the vehicle and the energy storage. This includes liquid cooling, communication, high voltage and low voltage connectors. The interface plate provides a weatherproof seal, alignment features, and touchless release for quick connect/disconnect.

Another aspect of the present disclosure involves a hot swap interface connector comprising an interface plate; energy storage connectors comprising a coolant connector; a low voltage and communication connector; a high voltage connector, wherein the hot swap interface connector is an all-in-one mechanical connector configured to allow all of the energy storage connectors into one interface between a vehicle and a hot swappable energy storage device.

One or more implementations of the aspect of the disclosure described immediately above includes one or more of the following: the interface plate includes alignment features; and/or the alignment features include one or pins and pin receivers.

A further aspect of the present disclosure involves a method of using a hot swap interface connector comprising providing a hot swappable energy storage device with a hot swap interface connector comprising an interface plate; energy storage connectors comprising a coolant connector; a low voltage and communication connector; a high voltage connector, wherein the hot swap interface connector is an all-in-one mechanical connector configured to allow all of the energy storage connectors into one interface between a vehicle and a hot swappable energy storage device; connecting the hot swappable energy storage device with the hot swap interface connector to a vehicle via the hot swap interface connector; transmitting coolant via the coolant connector; transmitting low-voltage power and communications signals via the lower-voltage and communication connector; transmitting high-voltage power via the high-voltage connector.

One or more implementations of the aspect of the disclosure described immediately above includes disconnecting and removing from the vehicle a hot swappable energy storage device with hot swap interface connector to be replaced prior to connecting the hot swappable energy storage device with the hot swap interface connector to the vehicle via the hot swap interface connector.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is simplified front elevational view of a hot swap interface connector.

FIG. 2 is front elevational view of a vehicle incorporating the swap interface connector of FIG. 1.

FIG. 3 is a flow chart of an exemplary method of using the hot swap interface connector of FIG. 1.

### DESCRIPTION OF EMBODIMENT OF THE INVENTION

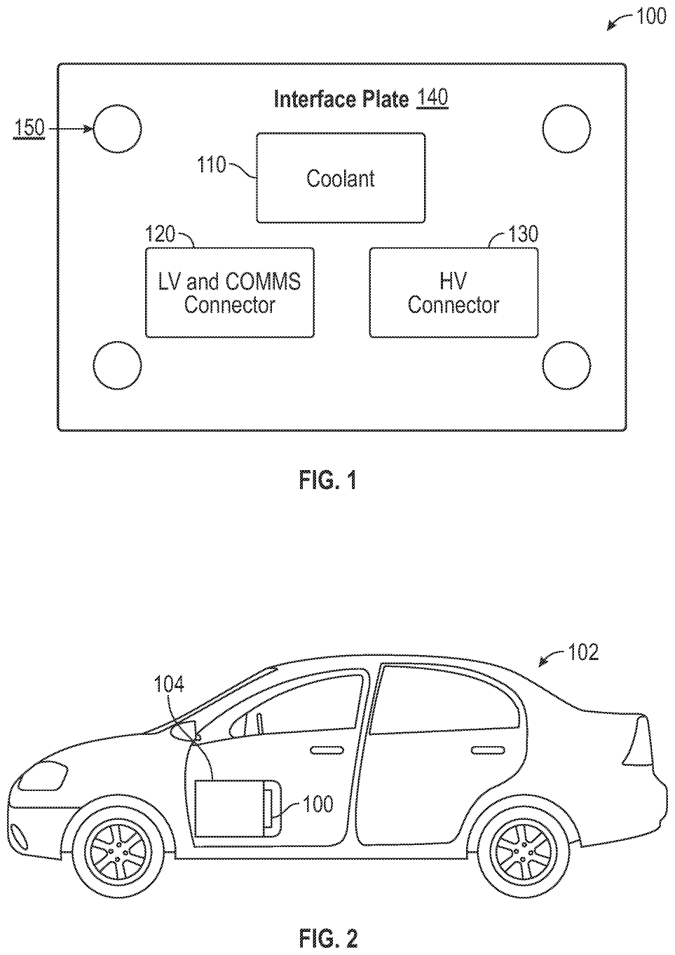

With reference to FIGS. 1 and 2, an embodiment of a hot swap interface connector 100 will be described. The hot swap interface connector 100 is an all-in-one mechanical connector that allows all energy storage connectors into one interface between a vehicle (e.g., auto, truck, train, trolley, bus, off-road vehicle, boat) 102 and a hot swappable energy storage device 104. The energy storage connectors include a coolant/liquid cooling connector 110, a low voltage (LV) and communication (COMMS) connector 120, and a high voltage (HV) connector 130. An interface plate 140 provides a weatherproof seal, alignment features (via alignment pins 150, pin-receivers), and touchless release for quick connect/disconnect.

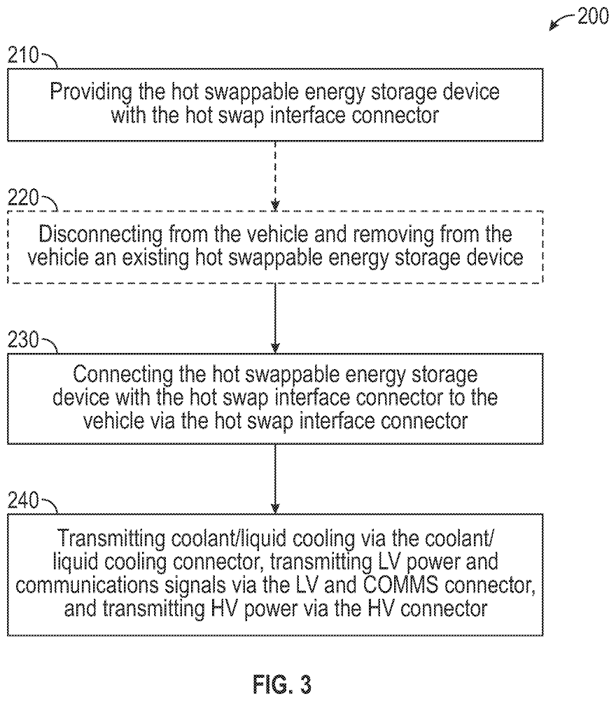

With reference to FIG. 3, a method 200 of using the hot swap interface connector 100 comprises, at step 210, providing the hot swappable energy storage device 104 with the hot swap interface connector 100; at optional step 220, disconnecting from the vehicle 102 and removing from the vehicle 102 an existing hot swappable energy storage device; at step 230, connecting the hot swappable energy storage device 104 with the hot swap interface connector 100 to the vehicle 102 via the hot swap interface connector 100; at step 240, transmitting coolant/liquid cooling (e.g., from the vehicle 102 to the hot swappable energy storage device 104) via the coolant/liquid cooling connector 110; transmitting low voltage (LV) power and communications signals (e.g., from the hot swappable energy storage device 104 to the vehicle 102, between the hot swappable energy storage device 104 and the vehicle 102) via the low voltage (LV) and communication (COMMS) connector 120, and transmitting high voltage (HV) power (e.g., from the hot swappable energy storage device 104 to the vehicle 102) via the high voltage (HV) connector 130.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I/We claim:

1. A hot swap interface connector, comprising:
an interface plate;
energy storage connectors comprising:
a coolant connector;
a low voltage and communication connector;
a high voltage connector,
wherein the hot swap interface connector is an all-in-one mechanical connector configured to allow all of the energy storage connectors into one interface between a vehicle and a hot swappable energy storage device.

2. The hot swap interface connector of claim 1, wherein the interface plate includes alignment features.

3. The hot swap interface connector of claim 2, wherein the alignment features include one or pins and pin receivers.

4. A method of using a hot swap interface connector, comprising:
providing a hot swappable energy storage device with the hot swap interface connector;
connecting the hot swappable energy storage device with the hot swap interface connector to a vehicle via the hot swap interface connector;
transmitting coolant via the coolant connector;
transmitting low-voltage power and communications signals via the lower-voltage and communication connector;
transmitting high-voltage power via the high-voltage connector.

5. The method of claim 4, further comprising disconnecting and removing from the vehicle a hot swappable energy storage device with hot swap interface connector to be replaced prior to connecting the hot swappable energy storage device with the hot swap interface connector to the vehicle via the hot swap interface connector.
